(19) United States
(12) Patent Application Publication
(10) Pub. No.: US 2025/0085906 A1
(43) Pub. Date: Mar. 13, 2025

(54) NON-TRANSITORY COMPUTER-READABLE RECORDING MEDIUM STORING AN INSTALLER PROGRAM FOR INSTALLING CONTROL PROGRAM ON TERMINAL DEVICE, TERMINAL DEVICE, AND METHOD FOR CONTROLLING TERMINAL DEVICE

(71) Applicant: BROTHER KOGYO KABUSHIKI KAISHA, Nagoya (JP)

(72) Inventor: Junya ASANO, Gifu (JP)

(21) Appl. No.: 18/825,036

(22) Filed: Sep. 5, 2024

(30) Foreign Application Priority Data
Sep. 8, 2023 (JP) 2023-146475

(51) Int. Cl. G06F 3/12; G06F 8/61

(52) U.S. Cl. CPC G06F 3/123; G06F 3/1204; G06F 3/1286; G06F 3/1287; G06F 3/1288; G06F 8/61

(57) ABSTRACT

A non-transitory computer-readable recording medium may store an installer program for installing a control program for controlling a communication device on a terminal device, in which the installer program, when executed by a processor of the terminal device, causes the terminal device to: acquire specific device information related to a specific communication device; acquire, by using the specific device information, service information related to a service for shipping a consumable article to a user of the specific communication device; display, by using the service information, introduction information for introducing the consumable article shipping service to the user on a display of the terminal device; and install, by using the specific device information, the control program on the terminal device.

### REFERENCE TO RELATED APPLICATION(S)

This application claims priority from Japanese Patent Application No. 2023-146475 filed on Sep. 8, 2023. The entire content of the priority application is incorporated herein by reference.

### BACKGROUND ART

A technique in which a client terminal installs a driver configured to control a printer by using a plug-and-play installer is known.

### SUMMARY

The present disclosure provides an art configured to improve convenience for a user of a specific communication device controlled by a control program in a case where the control program for controlling a communication device is installed on a terminal device.

A non-transitory computer-readable recording medium disclosed herein may store an installer program for installing a control program for controlling a communication device on a terminal device, wherein the installer program, when executed by a processor of the terminal device, causes the terminal device to: acquire specific device information related to a specific communication device; acquire, by using the specific device information, service information related to a consumable article shipping service for shipping a consumable article to a user of the specific communication device; display, by using the service information, introduction information for introducing the consumable article shipping service to the user on a display of the terminal device; and install, by using the specific device information, the control program on the terminal device.

The above-mentioned terminal device displays the introduction information for introducing the consumable article shipping service for shipping a consumable article to the user of the specific communication device by using the installer program for installing the control program for controlling the communication device. Due to this, convenience for the user of the specific communication device can be improved.

A terminal device realized by the above installer program and a method for controlling the terminal device are also novel and useful.

### BRIEF DESCRIPTION OF DRAWINGS

FIG. 1 illustrates an overview of a communication system.

FIG. 2 illustrates an example for a service table and an account table.

FIG. 3 illustrates a flowchart of an installing process.

FIG. 4 illustrates a flowchart of an account information registration process.

FIG. 5 illustrates a sequence diagram for a specific process.

FIG. 6 illustrates a sequence diagram in continuation from FIG. 5.

FIG. 7 illustrates a sequence diagram of Case A.

FIG. 8 illustrates a sequence diagram of Case B.

### DESCRIPTION

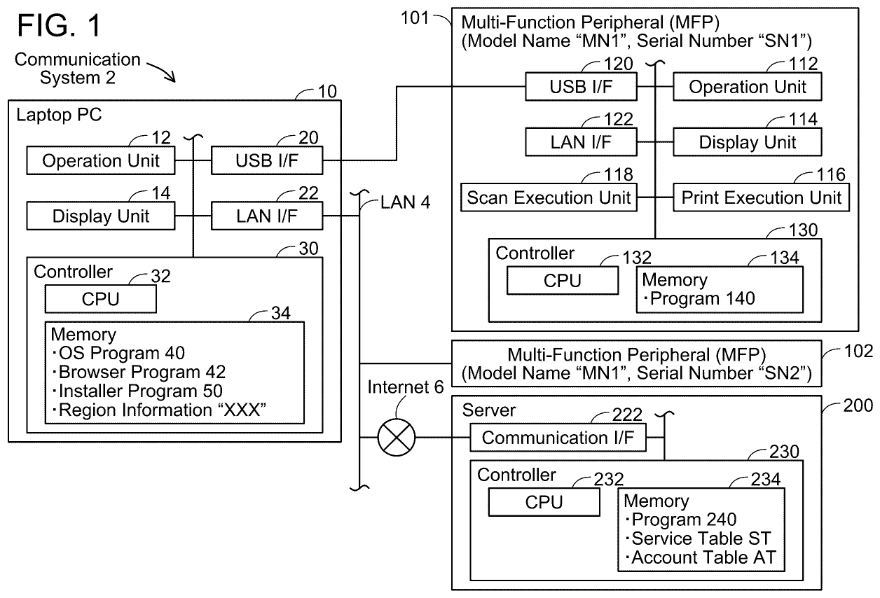

### (Configuration of Communication System 2: FIG. 1)

As illustrated in FIG. 1, a communication system 2 comprises a laptop PC 10, a plurality of multi-function peripherals 101 to 102, and a server 200. The laptop PC 10 belongs to a Local Area Network (LAN) 4. The multifunction peripheral 101 is configured to communicate with the laptop PC 10 by using a USB (Universal Serial Bus) scheme. The multifunction peripheral 102 is configured to communicate with the laptop PC 10 via the LAN 4. The LAN 4 is connected to the Internet 6. The laptop PC 10 and the multifunction peripheral 102 are configured to communicate with the server 200 via the LAN 4 and the Internet 6. Hereafter, a multi-function peripheral will be described as “MFP”.

### (Configurations of MFPs 101, 102)

The MFP 101 has a model name “MN1” and is assigned a serial number “SN1”. The MFP 102 has a model name “MN1” and is assigned a serial number “SN2”. The model name is an example for model identification information for identifying a model of an MFP, and each MFP 101, 102 may have a model identification number instead of the model name. The serial number is unique information for identifying an MFP.

The MFPs 101, 102 have a same configuration as each other. Hereafter, configuration of the MFP 101 will be described in detail. The MFP 101 is a peripheral device configured to execute a print function and a scan function (e.g., peripheral device for the laptop PC 10). In a modification, the MFP 101 may be configured to execute a FAX function in addition to the print function and the scan function. The MFP 101 comprises an operation unit 112, a display unit 114, a print executing unit 116, a scan executing unit 118, a USB interface 120, a LAN interface 122, and a controller 130. The respective components 112 to 130 are connected to a bus line. Hereafter, interface will be referred to as “I/F”.

The operation unit 112 is an I/F for inputting various information to the MFP 101 and comprises button(s) and/or touch screen, for example. The display unit 114 is a display for displaying various information. The print executing unit 116 comprises a print mechanism such as an inkjet scheme. The print mechanism may be referred to as “print engine”. In a modification, the print executing unit 116 may comprise a print mechanism different from the inkjet scheme, such as a laser scheme print mechanism or a thermal print mechanism. The scan executing unit 118 comprises a read mechanism such as a CCD scheme or a CIS scheme. The read mechanism may be referred to as “scan engine”. The USB I/F 120 is an I/F to which a USB cable is connected. The LAN I/F 122 is an I/F for being connected to the LAN 4. The LAN 4 may be a wired LAN or a wireless LAN.

The controller 130 comprises a CPU 132 and a memory 134. The memory 134 comprises a primary storage and an auxiliary storage. The primary storage comprises a RAM and a cache memory, for example. The auxiliary storage may be a flash memory, a solid state drive (SSD), ROM, or a combination thereof. The memory 134 has a program 140 stored therein. The program 140 is stored in the auxiliary storage of the memory 134. The CPU 132 executes various process in accordance with a program loaded to the primary storage from the auxiliary storage of the memory 134. The memory 134 stores the model name “MN1” and the serial number “SN1” of the MFP 101. Here, the memory of the MFP 102 stores the model name “MN1” and the serial number “SN2” of the MFP 102.

### (Configuration of Laptop PC 10)

The laptop PC 10 comprises an operation unit 12, a display unit 14, a USB interface 20, a LAN interface 22, and a controller 30. The respective components 12 to 30 are connected to a bus line.

The operation unit 12 is an I/F for inputting various information to the laptop PC 10, and comprises a mouse, keyboard, for example. The display unit 14 is a display for displaying various information. The USB I/F 20 is an I/F to which a USB cable is connected. The LAN I/F 22 is an I/F for being connected to the LAN 4.

The controller 30 comprises a CPU 32 and a memory 34. The memory 34 comprises a primary storage and an auxiliary storage. The primary storage comprises a RAM and a cache memory, for example. The auxiliary storage may be a flash memory, a solid state drive (SSD), ROM, or a combination thereof. The memory 34 stores an OS program 40, a browser program 42, an installer program 50, and region information “XXX”. These programs 40, 42, 50 are stored in the auxiliary storage of the memory 34. The CPU 32 realizes various processes in accordance with a program loaded from the auxiliary storage to the primary storage of the memory 34. Hereafter, the OS program 40 will be referred to as “OS 40”, the browser program 42 will be referred to as “browser 42”, and the installer program 50 will be referred to as “installer 50”.

The OS 40 controls basic operation of the laptop PC 10. The browser 42 is a general webpage browser software, and is for example Microsoft Edge, Safari, GoogleChrome. “Microsoft Edge” is a registered trademark of “Microsoft Corporation”. “Safari” is a registered trademark of “Apple, Inc”. “GoogleChrome” is a registered trademark of “Google LLC”. The installer 50 is a program for installing a control program for controlling the MFPs 101, 102 on the laptop PC 10. The control program includes for example a printer driver program (hereafter “driver” simply), an MFP application, and a status monitor.

The driver is configured to cause the MFPs 101, 102 to execute a print function. The MFP app is configured to cause the MFPs 101, 102 to execute a print function and a scan function. The MFP app is further configured to accept a change of print setting, scan setting, for example. The print setting includes for example a print resolution, print color information (monochrome, grayscale, and color), and/or a paper size. The scan setting includes for example, a location for storing scan data and/or a scan resolution. The status monitor is a program for checking a status of the MFPs 101, 102 and is configured to display status information acquired from the MFPs 101, 102. The status for example includes a print condition and/or remaining amount(s) of consumable article(s).

The installer 50 is downloaded to the laptop PC 10 after shipment of the laptop PC 10. The installer 50 has an execution file (e.g., exe file) and a plurality of modules. The plurality of modules includes, for example, a WebView module. When a user activates (e.g., double-click) the execution file for the installer 50, the installer 50 executes processes for installing the above-mentioned control program. The installer 50 may be incorporated into the laptop PC 10 from a medium shipped with the MFPs 101, 102, or may be downloaded to the laptop PC 10 from a server arranged by a vendor of the MFPs 101, 103 (e.g., from the server 200).

In initial setting for the laptop PC 10, a user designates a region where the laptop PC 10 is used (e.g., Japan, the U.S.A, or Europe). At this time, the memory 34 stores region information “XXX” indicative of the region designated by the user.

### (Configuration of Server 200)

The server 200 is a server configured for provision of a service to a user of an MFP (e.g., 101). The server 200 is arranged on the Internet 6 by, for example, a vendor of the MFPs 101, 102. The server 200 may be arranged by a company different from the vendor of the MFPs 101, 102. The server 200 may be realized by a single server, or by a plurality of servers cooperating. The server 200 may be a physical server, or may be realized by a program for a server being mounted on a platform. Hereafter, as an example, a case where the server 200 is a physical server will be described.

The server 200 comprises a communication I/F 222 and a controller 230. The respective units 222 and 230 are connected to a bus line (reference numerals omitted). The communication I/F 222 is connected to the Internet 6.

The controller 230 comprises a CPU 232 and a memory 234. The memory 234 has a configuration same as that of the memory 34 of the laptop PC 10. The memory 234 stores a program 240, a service table ST, and an account table AT. The program 240 is stored in an auxiliary storage of the memory 234. The CPU 232 executes various processes in accordance with a program loaded from the auxiliary storage to a primary storage of the memory 234.

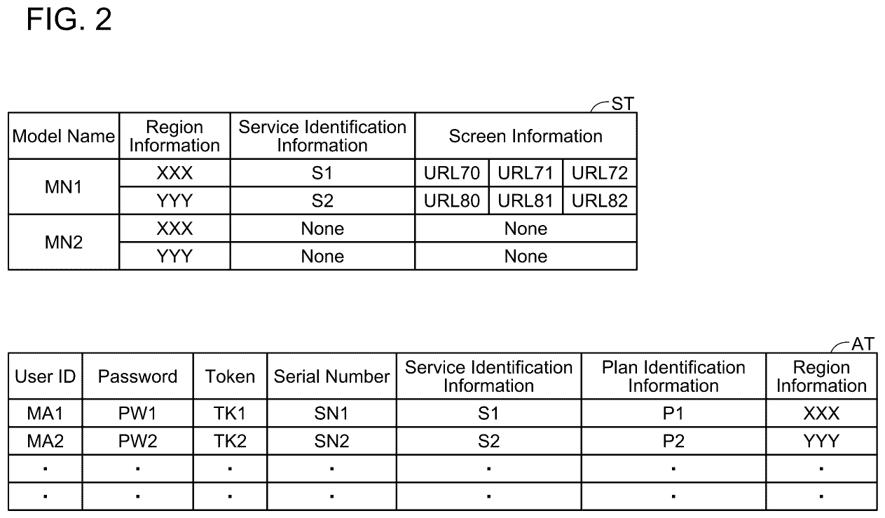

### (Contents of Service Table ST and Account Table AT; FIG. 2)

With reference to FIG. 2, contents of the service table ST and the account table AT will be described. The service table ST is a table for storing information related to service(s). The account table AT is a table for storing information related to user account(s) for an MFP.

In the service table ST, a model name, region information, service identification information, and screen information are stored in association with each other. The model name indicates a model of an MFP. The region information is for identifying a region in which the MFP is used. The service identification information is for identifying a service. In the present embodiment, the service identification information includes “S1” for identifying a consumable article shipping service and “S2” for identifying a subscription service. The screen information includes a URL of a website. The screen information includes a URL 70 of a website which introduces the consumable article shipping service to the user, a URL 71 of an input screen SC 30 to be described later, a URL 72 of a service plan screen to be described later, a URL 80 of a website which introduces the subscription service to the user, a URL 81 of an input screen for the subscription service, and a URL 82 of a service plan screen of the subscription service.

The consumable article shipping service is a service which automatically ships a new cartridge in a case where a remaining amount of ink in a cartridge mounted in an MFP becomes a predetermined remaining amount or lower. The subscription service is a service which charges a fixed fee in a case where a number of printed sheets during a predetermined time period (e.g., one month) is a contracted number of printed sheets (e.g., 1000 sheets) or less and charges a fee obtained by totaling the fixed fee and a price complying with a number of printed sheets exceeding the contracted number of printed sheets in a case where the number of printed sheets during the predetermined time period exceeds the contracted number of printed sheets. The subscription service includes a service equivalent to the above-mentioned consumable article shipping service.

In the example of FIG. 2, the model name “MN1” and the region information “XXX” are associated with the service identification information “S1”. This means that, in a case where an MFP (e.g., 101, 102) having the model name “M1” is used in a region indicated by the region information “XXX”, a user of such MFP can receive provision of the consumable article shipping service identified by the service identification information “S1”. The model name “MN1” and the region information “YYY” are associated with the service identification information “S2”. This means that, in a case where an MFP having the model name “MN1” is used in a region indicated by the region information “YYY”, a user of such MFP can receive provision of the subscription service identified by the service identification information “S2”. Further, the model name “MN2” is not associated with the service identification information. This means that a user of an MFP having the model name “MN2” cannot receive provision of a service regardless of the region. Information in the service table ST is stored in advance by a business entity which manages the server 200.

In the account table AT, a user ID, a password, a token, a serial number, service identification information, plan identification information, and region information are stored in association with each other. The user ID is unique information for identifying a user, and is for example an email address of the user. The password is a character string designated by the user. The token is authentication information generated by the server 200 from the user ID and password, and is, in other words, information for logging in to the server 200. The plan identification information indicates a service plan contracted by the user from among a plurality of service plans, which is predetermined according to a model of an MFP, for example. In a case of the consumable article shipping service, a cartridge type may differ between different service plans, for example. In a case of the subscription service, a fixed fee price, a contracted number of printed sheets, and/or a print type (e.g., monochrome print, color print) may differ between different service plans, for example. When the user accesses the server 200 and inputs a user ID and a password, the user ID, the password, and a token are stored in the account table AT. The serial number, the service identification information, the plan identification information, and the region information are stored in the account table AT by communication to be described later being executed.

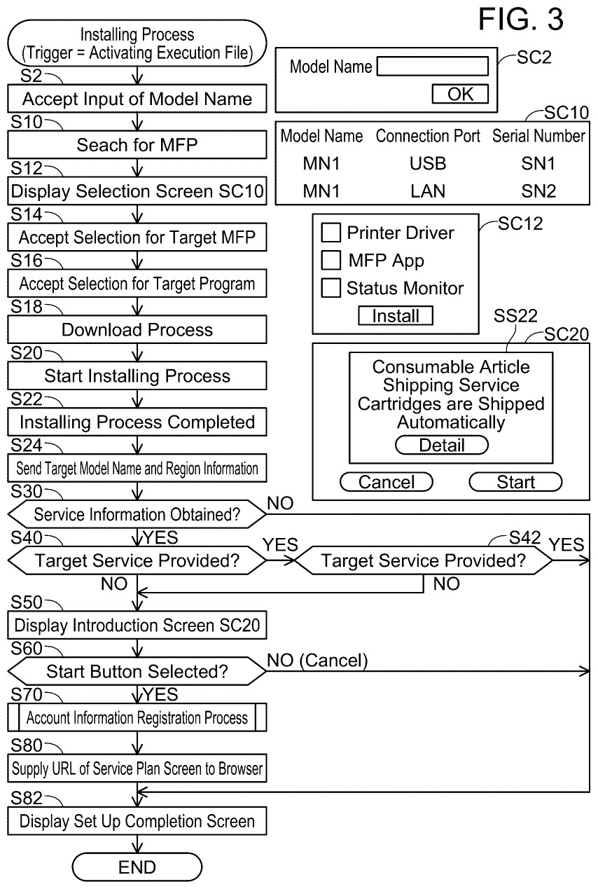

### (Installing Process; FIG. 3)

An installing process realized by the CPU 32 of the laptop PC 10 executing the installer 50 will be described. The CPU 32 starts a process of FIG. 3 in response to the execution file for the installer 50 being activated. Hereafter, operations executed by the CPU 32 following the installer 50 will be described with the installer 50 as a subject of action, without describing the CPU 32 as the subject of action.

In S2, the installer 50 accepts input of a model name of an MFP (e.g., “MN1”) which is a control target for a control program from a user. Specifically, the installer 50 displays a model name input screen SC2 on the display unit 14. Further, when the installer 50 accepts selection of an OK button on the model name input screen SC2 from a user after a model name has been inputted by the user in a model name inputting field on the model name input screen SC2, the installer 50 acquires the inputted model name inputted in the model name inputting field. Hereafter, the model name acquired in S2 may be referred to as “target model name”.

In S10, the installer 50 searches for an MFP. Specifically, the installer 50 sends a search signal to the LAN 4. Due to this, each of one or more MFPs (e.g., 102) belonging to the LAN 4 sends a response signal. The response signal includes the model name and the serial number of the sender MFP.

When the installer 50 receives the respective response signal from each MFP, the installer 50 specifies a response signal including the target model name from among those response signals. Next, in S12, the installer 50 displays a selection screen SC10 on the display unit 14. The selection screen SC10 includes the target model name, a connection port “LAN”, and the serial number included in the specified response signal. Also, when an MFP (e.g., 101) is connected to the USB I/F 20 of the laptop PC 10 via a USB cable, the model name and the serial number of that MFP are stored in the memory 34. In a case where the model name matching the target model name and the serial number are stored in the memory 34, the installer 50 displays the target model name, the connection port “USB”, and the serial number on the selection screen SC10.

Subsequently, in S14, the installer 50 accepts selection of an MFP which is a control target to be controlled by the control program from the user on the selection screen SC10. Hereafter, the MFP selected in S14 may be referred to as “target MFP”.

In S16, the installer 50 accepts selection of one or more of control programs to be installed on the laptop PC 10 from the user. Specifically, the installer 50 displays, on the display unit 14, a program selection screen SC12 including names of various control programs (e.g., driver, MFP app, status monitor) that are compatible with the target model name for which input was accepted in S2. The installer 50 accepts selection of one or more of the control programs from the user by using checkboxes on the program selection screen SC12. When an Install button on the program selection screen SC12 is selected with one or more of the checkboxes selected, an installing process for the control program(s) corresponding to the selected checkbox(es) is started. Hereafter, the control program(s) selected in S16 (e.g., driver) may be referred to as “target program(s)”.

In S18, the installer 50 executes a download process. Specifically, when the Install button on the program selection screen SC12 is selected in S16, the installer 50 sends control program information to the server 200 which provides the control program(s). The control program information includes a target model name and program type information indicating a target program for which selection was accepted in S16. Due to this, the installer 50 receives the control program (i.e., target program) specified by the target model name and the program type information from the server 200 which received the control program information. Due to this, the target program is downloaded to the laptop PC 10. Alternatively in a modification, the installer 50 may have control program(s) compatible with various model names. In this case, the installer 50 may supply a target program for which selection was accepted in S16 to the laptop PC 10. In the present modification, the process in S18 may be omitted.

In S20, the installer 50 starts an installing process of installing the target program downloaded in S18 to the laptop PC 10.

In S22, the installer 50 completes installation of the target program.

In S24, the installer 50 sends the target model name acquired in S2 and the region information (e.g., “XXX”) stored in the memory 34 to the server 200.

As illustrated in the service table ST in FIG. 2, for example, the model name “MN1” and the region information “XXX” are associated with the service identification information “S1” and screen information. Due to this, in a case where the model name “MN1” and the region information “XXX” are sent to the server 200 in S24, the server 200 sends service information including the service identification information “S1” and the screen information (i.e., the URLs 70, 71, 72) to the laptop PC 10. Contrary to this, the model name “MN2” is not associated with the service identification information. Due to this, in a case where the model name “MN2” and the region information “XXX” are sent to the server 200 in S24, the server 200 does not send the service information to the laptop PC 10.

In S30, the installer 50 determines whether the service information has been acquired from the server 200 or not. Due to this, the installer 50 determines whether a service that can be provided to the user exists or not in a case where the target MFP is used in a region indicated by the region information sent in S24. In a case where the installer 50 receives the service information from the server 200, the installer 50 determines YES to S30 and proceeds to S40, and in a case where the installer 50 does not receive the service information from the server 200, the installer 50 determines NO to S30 and proceeds to S82. As such, the installer 50 acquires the service information complying with the target model name. Due to this, the laptop PC 10 can suitably acquire information regarding a service that can be provided to the user of the target MFP.

In S40, the installer 50 determines whether the service identified by the service identification information included in the service information received in S30 (hereafter, “target service”) has been provided to the user of the target MFP. Specifically, the installer 50 sends an inquiry signal including the service identification information of the target service to the target MFP. Due to this, in a case where the target service has been provided to the user, the target MFP sends a response signal indicating that it has been provided to the laptop PC 10, and in a case where the target service has not been provided to the user, the target MFP sends a response signal indicating that it has not been provided to the laptop PC 10. In a case where the response signal indicates that it has been provided, the installer 50 determines YES to S40 and proceeds to S42, and in a case where the response signal indicates that it has not been provided, the installer 50 determines NO to S40 and proceeds to S50.

In S42, the installer 50 determines whether a valid token is stored in a predetermined area within the memory 34 or not. For example, in a case where the user has contracted for receiving the provision of the target service by using the laptop PC 10 before the process of FIG. 3 is executed, a user ID and a password are inputted to the server 200. In this case, the server 200 uses the user ID and the password to generate a token, and sends the token to the laptop PC 10. As a result of this, the token is stored in the predetermined area within the memory 34 of the laptop PC 10. In a case where, however, the user makes the above-mentioned contract by using a terminal different from the laptop PC 10, the token is not stored in the predetermined area within the memory 34 because the server 200 does not send the token to the laptop PC 10. In this case, even if the target service has been provided to the user (YES to S40), the token is not stored in the memory 34 (NO to S42).

When a predetermined time elapses after the token is generated, the server 200 invalidates the token. In a case where the token is stored in the predetermined area within the memory 34, the installer 50 sends the token to the server 200, and checks validity of the token. In a case where the installer 50 receives information indicating that the token has been successfully authenticated from the server 200, the installer 50 determines that the valid token is stored in the memory 34 (YES to S42), and in a case where the installer 50 receives information indicating that the authentication of the token has failed from the server 200, the installer 50 determines that the valid token is not stored in the memory 34 (NO to S42). In a case where YES is determined to S42, the installer 50 proceeds to S82, and in a case where NO is determined to S42, the installer 50 proceeds to S50.

In S50, the installer 50 causes the display unit 14 to display an introduction screen SC20. The introduction screen SC20 is for introducing that the user of the target MFP can receive the provision of the target service. The introduction screen SC20 includes a service screen SS22, a Cancel button, and a Start button. When the installer 50 is causing the display unit 14 to display the introduction screen SC20, the installer 50 supplies a URL (e.g., URL 70) included in the screen information in the service information received in S30 to the WebView module. Due to this, the WebView module accesses the URL, acquires screen data representing the service screen SS22, and displays the service screen SS22 in the introduction screen SC20. In an example of FIG. 3, the service screen SS22 includes a message indicating that he/she can receive the consumable article shipping service, a message indicating an overview of the consumable article shipping service, and a Detail button. The Detail button is a button for displaying information indicative of details of the consumable article shipping service. Here, the installer 50 may acquire the service screen SS22 by using the WebView function mounted in the OS 40, or may acquire the service screen SS22 by using the browser 42.

In a case where the target service has been provided to the user (YES to S40, YES to S42), the installer 50 does not cause the display unit 14 to display the introduction screen SC20. This is because it might bother the user if the introduction screen SC20 about the already-provided service is displayed.

In S60, the installer 50 determines whether selection of the Start button has been accepted or not from the user. In a case where the installer 50 accepts the selection of the Start button from the user, the installer 50 determines YES to S60 and proceeds to S70 and in a case where the installer 50 accepts selection of the Cancel button from the user, the installer 50 determines NO to S60 and proceeds to S82.

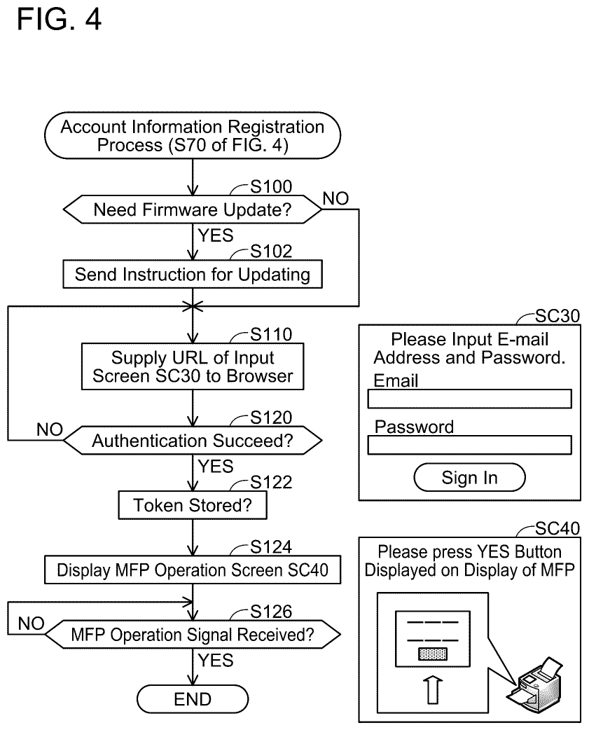

In S70, the installer 50 executes an account information registration process (FIG. 4). The account information registration process comprises accepting an input of a user ID and a password from a user and storing account information including the user ID and the password in the account table AT. When S70 ends, the installer 50 proceeds to S80.

In S80, the installer 50 displays a service plan screen on the display unit 14. Specifically, the installer 50 activates the browser 42, and supplies, to the browser 42, the URL (e.g., URL 72) included in the screen information in the service information received in S30. The browser 42 accesses that URL to receive screen data, and displays the service plan screen. Although not illustrated, the service plan screen is for accepting a user's selection of one service plan from among plural service plans corresponding to the target service from a user. When the browser 42 accepts selection of a service plan from the user on the service plan screen, the browser 42 sends plan information to the server 200. The plan information includes a serial number of the target MFP selected in S14, the region information stored in the memory 34, the service identification information included in the service information received in S30, the plan identification information indicating the service plan selected in S80, and the token. Due to this, the server 200 stores, in association with the token, the serial number, the region information, the service identification information, and the plan identification information in the account table AT.

In S82, the installer 50 causes the display unit 14 to display a setup completion screen. The setup completion screen indicates that installation of the target program has been completed. When S82 ends, the process of FIG. 3 ends.

### (Account Information Registration Process; FIG. 4)

Subsequently, with reference to FIG. 4, the account information registration process executed in S70 in FIG. 3 will be described.

In S100, the installer 50 determines whether it is necessary to update a firmware of the target MFP in order to provide the target service via the target MFP or not. Specifically, the installer 50 sends a firmware information request to the target MFP, and receives firmware information of the target MFP from the target MFP. The firmware information includes firmware identification information of the target MFP and version information indicating a current version of the firmware, for example. The installer 50 uses the firmware information and thus determines whether it is necessary to update the firmware of the target MFP or not. In a case where the current version of the firmware is compatible with the target service, the installer 50 determines that it is not necessary to update the firmware (NO to S100), and proceeds to S110. In a case where the current version of the firmware is not compatible with the target service, the installer 50 determines that it is necessary to update the firmware (YES to S100), and proceeds to S102.

In S102, the installer 50 sends an update instruction to the target MFP. Due to this, the target MFP can be caused to update the firmware. As such, because the update of the firmware for receiving provision of the target service is automatically executed, user convenience can be improved.

In S110, the installer 50 causes the display unit 14 to display an input screen SC30. Specifically, the installer 50 activates the browser 42, and supplies the URL (e.g., URL 71) included in the screen information in the service information received in S30 in FIG. 3 to the browser 42. The browser 42 accesses the URL, receives screen data representing the input screen SC30, and displays the input screen SC30. The input screen SC30 includes a message prompting the user to input an email address (i.e., user ID) and a password, an email inputting field, and a Sign In button. The browser 42 sends the inputted user ID and password inputted in the respective inputting fields in the input screen SC30 to the server 200. In a case where the account information is stored in the account table AT, the server 200 sends authentication success information including a token generated by that account information to the browser 42, and in a case where that account information is not stored in the account table AT, the server 200 sends authentication failure information to the browser 42.

In S120, the installer 50 determines whether the authentication of the account information inputted in S110 has succeeded or not. Here, in S110, the installer 50 had supplied an address indicating a local host area of the laptop PC 10 to the browser 42, along with the URL of the input screen SC30. When the browser 42 receives the authentication success information from the server 200, the browser 42 accesses the local host area by using the address supplied from the installer 50. In S120, the installer 50 monitors whether the browser 42 accesses the local host area or not. In a case where the browser 42 accesses the local host area, the installer 50 determines that the authentication has succeeded (YES to S120) and proceeds to S122, and in a case where the browser 42 does not access the local host area, the installer 50 determines that the authentication has failed (NO to S120) and proceeds to S110.

In S122, the installer 50 acquires the token included in the authentication success information from the browser 42, and stores the token in the predetermined area within the memory 34. Due to this, in a case where the process of FIG. 3 is executed again in order to install another control program different from the target program (e.g., MFP app), the installer 50 determines YES to S42 and can omit the process of S70.

Next, in S124, the installer 50 firstly sends a display instruction to the target MFP. The display instruction is for displaying a predetermined button (“YES” button in the present embodiment) on the display unit of the target MFP. Subsequently, the installer 50 causes the display unit 14 to display an MFP operation screen SC40 which the installer 50 already has. The MFP operation screen SC40 includes a message prompting the user to operate the “YES” button displayed on the display unit of the target MFP and an image indicating a location of the “YES” button.

In S126, the installer 50 monitors for receiving from the target MFP of an MFP operation signal indicating that operation on the “YES” button has been accepted from the user. When the installer 50 receives the MFP operation signal from the target MFP, the installer 50 determines YES to S126 and ends the process of FIG. 4.

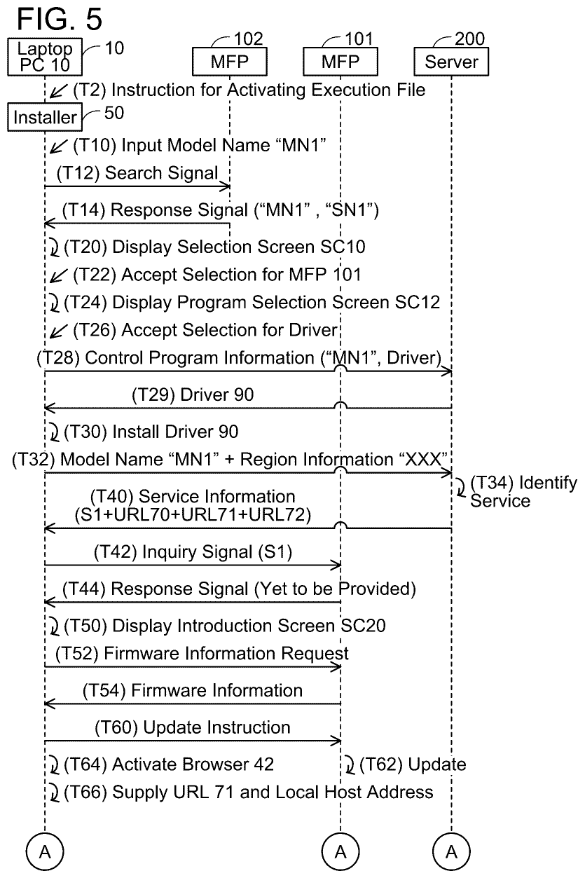

### (Specific Cases; FIGS. 5 to 8)

Next, specific cases executed by the process of FIGS. 3 and 4 will be described. At an initial state of FIG. 5, the laptop PC 10 is communicable with the MFP 101 via the USB I/F 20 and is communicable with the MFP 102 via the LAN 4.

In T2, the laptop PC 10 receives an instruction for activating the execution file of the installer 50 (trigger of FIG. 3). Due to this, the installer 50 is activated. In T10, the installer 50 accepts input from the user of the model name “MN1” (S2). In this case, in T12, the installer 50 sends a search signal to the LAN 4 (S10).

When the MFP 102 receives the search signal from the laptop PC 10 in T12, in T14 the MFP 102 sends a response signal to the laptop PC 10. The response signal includes the model name “MN1” and the serial number “SN2” of the MFP 102.

When the installer 50 receives the response signal from the MFP 102 in T14, in T20 the installer 50 displays the selection screen SC10 (S12). As illustrated in FIG. 3, the selection screen SC10 includes the model name “MN1” and the serial number “SN1” of the MFP 101 connected by means of USB scheme and the model name “M1” and the serial number “SN2” included in the response signal received in T14. In the present case, in T22, the installer 50 accepts selection of the MFP 101 from the user (S14).

In T24, the installer 50 displays a program selection screen. In the present case, in T26, the installer 50 accepts selection of the driver (S16). In this case, in T28 the installer 50 sends the control program information including the model name “MN1” and program type information “driver” to the server 200 (S18).

When the server 200 receives the control program information from the laptop PC 10 in T28, in T29 the server 200 specifies a driver 90 by using the model name “MN1” and the program type information “driver” in the control program information, and sends the driver 90 to the laptop PC 10.

When the installer 50 receives (i.e., downloads) the driver 90 from the server 200 in T29, in T30 the installer 50 executes the installing process of the downloaded driver 90 (S20, S22). Further, in T32, the installer 50 sends the model name “MN1” of the MFP 101 selected in T22 and the region information “XXX” stored in the memory 34 to the server 200 (S24).

When the server 200 receives the model name “MN1” and the region information “XXX” from the laptop PC 10 in T32, in T34, the server 200 specifies the respective information (i.e., the service identification information “S1”, the screen information (e.g., the URL 70)) associated with the model name “MN1” and the region information “XXX” from the service table ST. Then in T40, the server 200 sends the service information including the specified respective information to the laptop PC 10.

When the installer 50 receives the service information from the server 200 (YES to S30) in T40, in T42 the installer 50 sends an inquiry signal to the MFP 101 (S40). The inquiry signal includes the service identification information “S1” included in the received service information.

At timing of T42, the consumable article shipping service has not been provided to the user of the MFP 101. For this reason, when the MFP 101 receives the inquiry signal from the laptop PC 10 in T42, in T44 the MFP 101 sends the response signal indicating that it has not been provided to the laptop PC 10.

When the installer 50 receives the response signal indicating that it has not been provided from the MFP 10 (NO to S40) in T44, in T50 the installer 50 displays the introduction screen SC20 (S50). In response to accepting the selection of the Start button the introduction screen SC20 from the user (YES to S60), in T52 the installer 50 sends the firmware information request to the MFP 101, and in T54 the installer 50 receives the firmware information from the MFP 101 (S100 in FIG. 4).

In the present case, at a timing of T54, for example, the version of the firmware of the MFP 101 is not a version required for receiving provision of the consumable article shipping service. Thus, the installer 50 determines that it is necessary to update the firmware of the MFP 101 (YES to S100). In this case, in T60 the installer 50 sends the update instruction to the MFP 101 (S102). Due to this, in T62 the MFP 101 updates the firmware.

Next, in T64, the installer 50 activates the browser 42, and in T66, supplies the URL 71 and the address of the local host area included in the service information received in T40 to the browser 42 (S110).

In T70, the browser 42 accesses the URL 71 and displays the input screen SC30. In T72, the browser 42 accepts input of the account information (i.e., a user ID “MA1” and password “PW1”). In this case, in T74 the installer 50 sends the inputted account information to the server 200.

When the server 200 receives the account information from the laptop PC 10 in T74, in T76 the server 200 authenticates the account information. In the present case, the account information including the user ID “MA1” and the password “PW1” has been stored in the account table AT. Thus, the authentication of the account information succeeds. In this case, in T78 the server 200 generates a token “TK1” by using the account information, and stores the token “TK1” in association with the account information in the account table AT. Further, in T79, the server 200 sends the authentication success information including the token “TK1” to the laptop PC 10.

When the browser 42 receives the authentication success information from the server 200 in T79, in T80 the browser 42 accesses the local host area by using the address acquired in T66 and stores the authentication success information in the local host area.

In a case where the authentication success information is stored in the local host area, the installer 50 determines that the authentication has succeeded (YES to S120). Then in T82, the installer 50 acquires the token “TK1” included in the authentication success information, and in T84 stores the token “TK1” in the predetermined area within the memory 34 (S122). In T86 the installer 50 sends a display instruction to the MFP 101.

When the MFP 101 receives the display instruction from the laptop PC 10 in T86, in T88 the MFP 101 displays the “YES” button on the display unit 114.

In T90, the installer 50 displays the MFP operation screen SC40 (S124).

In T92 the MFP 101 accepts selection of the “YES” button from the user who saw the MFP operation screen SC40. In this case, in T94 the MFP 101 sends the MFP operation signal to the laptop PC 10.

When in T94 the installer 50 receives the MFP operation signal from the MFP 101 (S126), in T96 the installer 50 activates the browser 42, and in T98 supplies the URL 72 to the browser 42 (S80). As such in response to receiving the MFP operation signal while the MFP operation screen SC40 is displayed, the installer 50 supplies the URL 72 to the browser 42. That is, after the installer 50 has confirmed that the user who is currently using the installer 50 and the user who is operating the MFP 101 are identical, the installer 50 can cause the browser 42 to display the service plan screen.

When the URL 72 is supplied from the installer 50 in T98, in T100 the browser 42 displays the service plan screen. In the present case, in T102, the browser 42 accepts selection of a service plan “P1” from the user. In this case, in T104 the browser 42 sends plan information to the server 200. The plan information includes the serial number “SN1” of the MFP 101, the region information “XXX” in the memory 34, the service identification information “S1”, the selected plan identification information “P1”, and the token “TK1”.

When the server 200 receives the plan information from the laptop PC 10 in T104, in T110 the server 200 stores the serial number “SN1”, the service identification information “S1”, the plan information “P1”, and the region information “XXX” in association with the token “TK1” that is, in association with the user ID “MA1” and the password “PW1” (see T78 in FIG. 5) in the account table AT. Due to this, the consumable article shipping service becomes available for provision to the user of the MFP 101.

In T112, the installer 50 displays the setup completion screen indicating that the installation of the driver 90 has been completed (S82).

Thereafter, in T120 the laptop PC 10 accepts a print instruction from the user. The print instruction includes designation of an image of print target (i.e., image to be printed) and designation of the model name “MN1” of the MFP 101 which is to execute printing. Due to this, the driver 90 compatible with the MFP 101 is activated. The driver 90 generates print data by converting the image of print target, and in T122 sends the print data to the MFP 101.

When in T122 the MFP 101 receives the print data from the laptop PC 10, in T124 the MFP 101 executes printing in accordance with the print data. Due to this, a print medium with the image of print target printed thereon is formed.

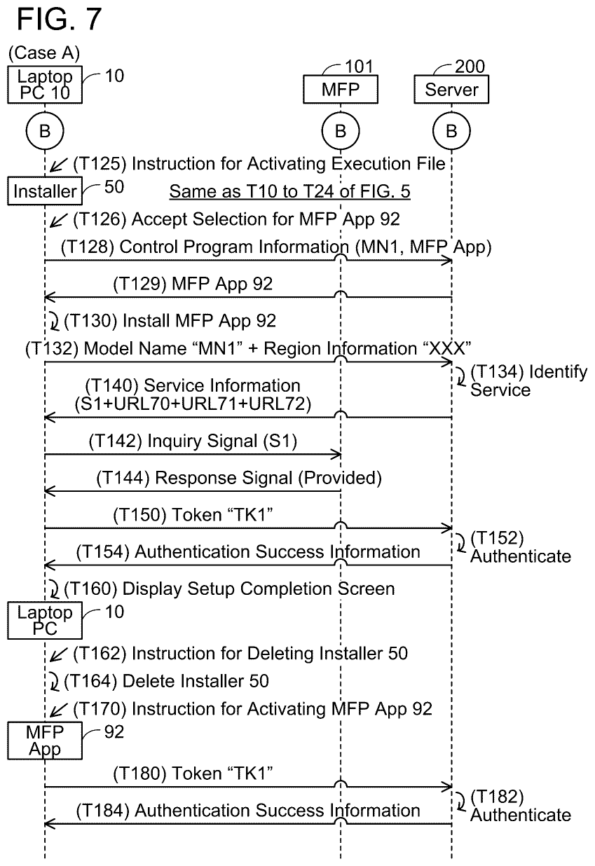

### (Case A; FIG. 7)

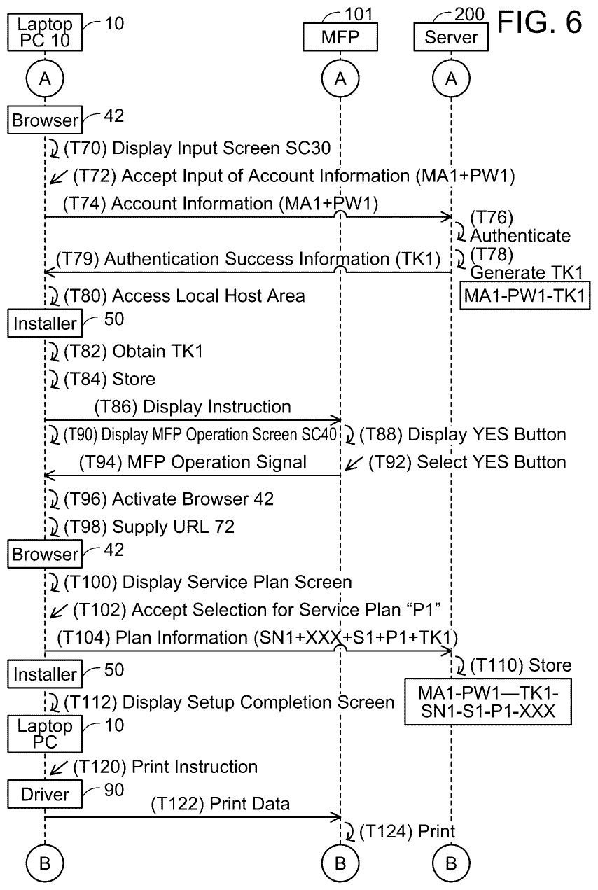

With reference to FIG. 7, Case A in continuation from FIG. 6 will be described. In T125, the laptop PC 10 accepts an instruction for activating the execution file of the installer 50 from the user (trigger of FIG. 3), and activates the installer 50. Thereafter, the same processes as T10 to T24 in FIG. 5 are performed between the installer 50 and the respective devices.

In the present case, in T126 the installer 50 accepts selection of the MFP app 92 from the user (S16). In this case, in T128 the installer 50 sends the control program information including the model name “MN1” and the program type information “MFP app” to the server 200 (S18).

When in T128 the server 200 receives the control program information from the laptop PC 10, in T129, the server 200 uses the model name “MN1” and the program type information “MFP app” included in the control program information to specify the MFP app 92, and sends the MFP app 92 to the laptop PC 10.

When the installer 50 receives (i.e., downloads) the MFP app 92 from the server 200 in T129, in T130 the installer 50 executes installing process of the downloaded MFP app 92 (S20, S22). Processes of T132 to T142 executed thereafter are the same as the processes of T32 to T42 in FIG. 5.

In the present case, the consumable article shipping service has been provided to the user of the MFP 101 (see T110 in FIG. 6). Due to this, when in T142 the MFP 101 receives the inquiry signal including the service identification information “S1” from the laptop PC 10, in T144 the MFP 101 sends a response signal indicating that it has been provided to the laptop PC 10.

When in T144 the installer 50 receives the response signal indicating that it has been provided from the MFP 10 (YES to S40), in T150 the installer 50 sends the token “TK1” stored in the predetermined area within the memory 34 (see T84 in FIG. 6) to the server 200.

When in T150 the server 200 receives the token “TK1” from the laptop PC 10, the server 200 authenticates the token “TK1”. Because in the present case the predetermined time has not elapsed since the token “TK1” was generated, the token “TK1” is valid. Due to this, the authentication of the token “TK1” succeeds, the laptop PC 10 can log in to the server 200. In T154 the server 200 sends the authentication success information to the laptop PC 10.

When in T154 the installer 50 receives the authentication success information from the server 200 (YES to S42), in T160 the installer 50 displays the setup completion screen indicating that the installation of the MFP app 92 has been completed (S82).

Next, in T162 the laptop PC 10 accepts an instruction to delete the installer 50 from the user. Due to this, in T164 the laptop PC 10 deletes the installer 50 from the memory 34.

In T170, the laptop PC 10 accepts an instruction to activate the MFP app 92. Due to this, the MFP app 92 is activated. In T180, the MFP app 92 sends the token “TK1” stored in the predetermined area within the memory 34 to the server 200.

When in T180 the server 200 receives the token “TK1” from the laptop PC 10, in T182 the server 200 authenticates the token “TK1”. In the present case, because the predetermined time has not elapsed since the token “TK1” was generated, the token “TK1” is valid. Due to this, in T184, the server 200 sends the authentication success information to the laptop PC 10. Due to this, the authentication of the token “TK1” succeeds, and thus the laptop PC 10 can log in to the server 200.

After the MFP app 92 logs in to the server 200, the MFP app 92 can for example acquire information stored in the server 200 (e.g., the serial number(s) stored in the account table AT, the service identification information, the plan identification information). Here, also in a case where the status monitor is installed instead of the MFP app 92, the status monitor can log in to the server 200 by using the token “TK1”. In this case, the status monitor can acquire status information of MFP(s) stored in the server 200.

As mentioned above, the MFP app 92 can log in to the server 200 by using the token “TK1” stored by the installer 50 in the predetermined area within the memory 34. Due to this, the user does not have to input the account information when accessing the server 200 by using the MFP app 92. Thus, user convenience can be improved. Especially even after the installer 50 has been deleted from the memory 34 (T164), the token “TK1” is kept stored in the predetermined area within the memory 34 which the MFP app 92 can reference to. Due to this, even when the user uses the MFP app 92 after the installer 50 has been deleted, the user does not have to input the account information.

Here, in a case where the valid token “TK1” is not stored in the predetermined area within the memory 34 (NO to S42) even if it is determined that the target service has been provided (YES to S40) in the above-mentioned installing process of FIG. 3, the installer 50 supplies the URL 71 of the input screen SC30 in the account information registration process in FIG. 4 to the browser 42 (S110 in FIG. 4). Due to this, the browser 42 accepts input of the account information. Thus, even in a case where the user makes a contract for the target service by using a terminal different from the laptop PC 10, the token “TK1” is stored in the predetermined area within the memory 34. Due to this, the user does not have to input the account information when the user uses the MFP app 92.

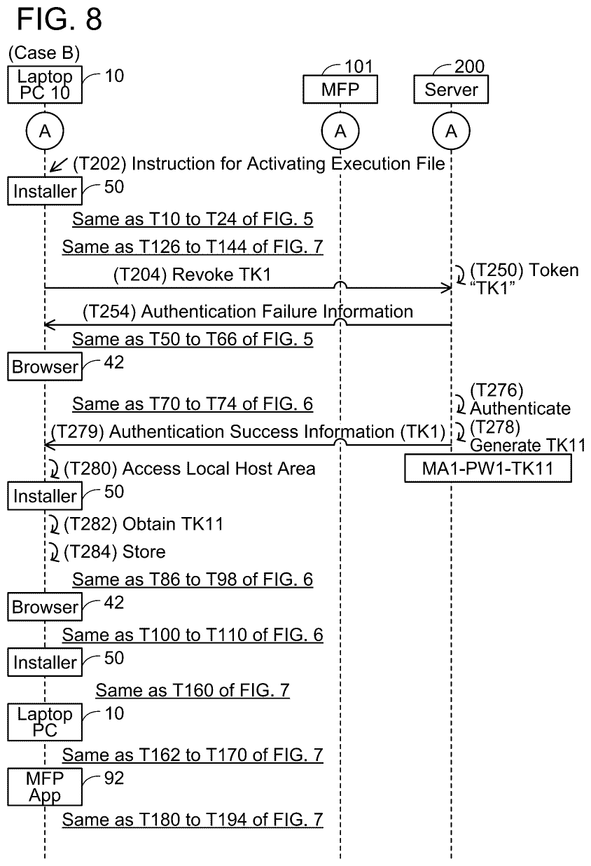

### (Case B; FIG. 8)

With reference to FIG. 8, Case B in continuation from FIG. 6 will be described. In T202, when the laptop PC 10 accepts an instruction for activating the execution file of the installer 50 from the user (trigger of FIG. 3), the laptop PC 10 activates the installer 50. Thereafter, processes same as T10 to T24 in FIG. 5 are executed between the installer 50 and the respective devices, and processes same as T126 to T144 in FIG. 7 are executed. In the present case, in T204, in response to the predetermined time elapsing, the server 200 invalidates the token “TK1”.

When in T250 the server 200 receives the token “TK1” from the laptop PC 10, the server 200 authenticates the token “TK1”. In the present case, the token “TK1” is invalid. Thus, the authentication of the token “TK1” fails. In this case, in T254, the server 200 sends the authentication failure information to the laptop PC 10.

When in T254 the installer 50 receives the authentication failure information from the server 200 (NO to S42), the installer 50 executes processes same as T50 to T66 in FIG. 5.

Subsequently, the browser 42 executes processes same as T70 to T74 in FIG. 6, accepts input from the user of the account information (the user ID “MA1” and the password “PW1”), and sends the inputted account information to the server 200 (S110).

When the server 200 receives the account information from the laptop PC 10, in T276 the server 200 authenticates the account information. In the present case, because the account information including the user ID “MA1” and the password “PW1” has already been stored in the account table AT, the authentication of the account information succeeds. In this case, in T278 the server 200 generates a new token “TK11” from the account information and stores the same in association with the account information in the account table AT. Further, in T279, the server 200 sends the authentication success information including the token “TK11” to the laptop PC 10.

When in T279 the browser 42 receives the authentication success information from the server 200, in T280 the browser 42 accesses the local host area by using the address acquired in T66 and stores the authentication success information in the local host area.

When the authentication success information is stored in the local host area, the installer 50 determines that the authentication has succeeded (YES to S120). Then in T282, the installer 50 acquires the token “TK11” included in the authentication success information, and in T284 the installer 50 stores the token “TK11” in a predetermined area within the memory 34 (S122). Thereafter, the installer 50 executes processes same as T86 to T98 in FIG. 6. Next, the browser 42 executes processes same as T100 to T110 in FIG. 6. Further, when the installer 50 executes processes same as T160 in FIG. 7, the laptop PC 10 executes processes same as T162 to T170 in FIG. 7 and the MFP app 92 executes processes same as T180 to T194 in FIG. 7. Due to this, in T284 the MFP app 92 can log in to the server 200 by using the new token “TK11” stored in the predetermined area within the memory 34.

Here in the present case, the case in which the installer 50 attempts to access the sever 200 by using the token “TK1” after in T204 the token “TK1” has been invalidated was described. However, the same applies to a case in which the token “TK1” is invalidated before the MFP app 92 sends the token “TK1” to the server 200 in T180 in FIG. 7. In this case, the MFP app 92 executes processes same as T64 and T66 in FIG. 5, and causes the browser 42 to display the input screen SC30. In this case, the browser 42 executes processes same as T70 to T74 in FIG. 6, and accepts input from the user of the account information (the user ID “MA1” and the password “PW1”). Further, the browser 42 sends the inputted account information to the server 200, and receives the authentication success information including a new token from the server 200. In this case, the MFP app 92 acquires the new token from the browser 42 and stores the new token in a predetermined area within the memory 34.

Due to this, in a case where, after the MFP app 92 has stored the new token in the predetermined area within the memory 34, the installer 50 is downloaded again and the execution file thereof is activated, the installer 50 can log in to the server 200 by using the new token stored in the predetermined area within the memory 34. Further, the new token is kept stored in the predetermined area within the memory 34 even after the MFP app 92 has been uninstalled. Due to this, even in a case where the user uses the installer 50 after the MFP app 92 has been uninstalled, the user does not have to input account information. Also, in a case where a status monitor is for example installed after the MFP app 92 has been installed without the installer 50 having been deleted in T164 in FIG. 7, the status monitor can log in to the server 200 by using the new token which the MFP app 92 stored in the predetermined area within the memory 34.

### Effects by Present Embodiment

The laptop PC 10 displays the introduction screen SC20 for introducing the consumable article shipping service that can be provided to the user of the MFP 101 by using the installer 50 for installing the control program for controlling the MFP 101 (S50 in FIG. 3). Due to this, convenience for the user of the MFP 101 can be improved.

### Correspondences

The driver 90 is an example for “control program”. The laptop PC 10 is an example for “terminal device”. The MFP 101 is an example for “specific communication device”. The model name “MN1” is an example for “specific device information”. The URL 70 is an example for “service information”. The introduction screen SC20 is an example for “introduction information”. The token “TK1” is an example for “authentication information”. The MFP app 92 is an example for “different program”. “The shipping a consumable article service” includes the above consumable article shipping service itself and a consumable article shipping service included in the above subscription service.

S2 and S30 in FIG. 3 are respectively examples executed by “acquire specific device information” and “acquire, service information related”. S50 in FIG. 3 and S110 in FIG. 4 are respectively examples of process executed by “display introduction information” and “display an input screen”. S20 and S22 in FIG. 3 are an example of process executed by “install the control program”. S122 in FIG. 4 is an example of process executed by “store authentication information”. S102 in FIG. 4 is an example for process executed by “send an instruction for updating the firmware”.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

(Modification 1) “target communication device” may not be limited to an MFP, but may be another device such as a printer, a scanner, a PC, a mobile terminal, or a server.

(Modification 2) The installer 50 may not execute the process of S2 in FIG. 3. In the present modification, in S12 the installer 50 may display the model name(s) of all the MFP(s) from which the response signal(s) were received on the selection screen SC10. In this case, in S14 the installer 50 may acquire the model name of the MFP selected by the user as the target model name. In the present modification, the target model name acquired in S14 is used in the downloading (S18) of the target program and the acquiring (S30) of the service information. In the present modification, the acquiring of the model name of the MFP selected in S12 is an example of process executed by “acquire specific device information”.

(Modification 3) In S24 in FIG. 3, the installer 50 may send the serial number of the target MFP instead of the model name of the target MFP to the server 200. In the present modification, in response to the target MFP being selected in S14, the installer 50 acquires the serial number of the target MFP. That is, in the present modification, the serial number of the target MFP is an example for the “specific device information”, and the process of S14 is an example of the process executed by “acquire specific device information”.

(Modification 4) The installer 50 may display a character string or an icon for introducing the consumable article shipping service on the setup completion screen for example in S82 instead of the introduction screen SC20. In the present modification, the character string or the icon is an example for the “introduction information”.

(Modification 5) The service information may not include the URL 70 of the service screen SS22. In the present modification, for example the installer 50 may have the URL 70 associated with the service identification information already stored therein. In this case, the installer 50 may use the service identification information included in the service information and thus specify the URL 70 to supply the same to the WebView module. Due to this, the service screen SS22 is displayed on the display unit 14. In the present modification, the installer 50 acquiring of the URL 70 stored in the memory 34 is an example of the process executed by “acquire service information”.

(Modification 6) The service table ST may not store the service identification information and the screen information in association with the model name and the region information. For example, the service table ST may store the service identification information and the screen information in association with feature identification information for identifying feature(s) of the target MFP (e.g., whether it has print function or not) and the region information. In the present modification, in S24 in FIG. 3, the installer 50 may send the feature identification information of the target MFP and the region information to the server 200. In this case, in S30 the installer 50 may acquire the service information related to a service specified by the feature identification information and the region information. In general terms, “acquire service information” may not comprise acquiring the service information that is compatible with the model of the target MFP identified by the target model name.

(Modification 7) The installer 50 may not execute the process of S40 in FIG. 3. That is, the installer 50 may cause the display unit 14 to display the introduction screen SC20 irrespective of whether the target service has been provided to the user of the target MFP or not.

(Modification 8) The installer 50 may not execute the process of S42 in FIG. 3. In this case, in a case where the installer 50 determines YES to S40, the installer 50 may proceed to S84. In another modification, in a case where the installer 50 determines NO to S42, the installer 50 may not display the introduction screen SC20 and may proceed to S70.

(Modification 9) The installer 50 may not execute the process of S122 in FIG. 4. In the present modification, “store authentication information” may be omitted. In another modification, in S122, the installer 50 may acquire the account information inputted in the input screen SC30 instead of the token from the browser 42, and store the same in a predetermined area within the memory 34. In the present modification, the account information is an example of “authentication information”.

(Modification 10) The installer 50 may execute the process of S30 to S40 from when the installing process of the driver in S20 in FIG. 3 was started until when the installing process has been completed in S22. That is, the installer 50 may cause the display unit 14 to display the introduction screen SC20 during the installation of the driver. Specifically, the installer 50 may start the process of S30 in response to the Install button on the program selection screen SC12 in FIG. 3 being selected. Due to this, the introduction screen SC20 can be displayed by the display unit 14 irrespective of whether the installation of the driver has been completed or not.

(Modification 11) The installer 50 may execute the process of S30 to S40 from when selection of the target serial number was accepted in S14 in FIG. 3 until when the installing process is started in S20. That is, the installer 50 may cause the display unit 14 to display the introduction screen SC20 before the installation of the driver is started.

(Modification 12) The installer 50 may not execute the process of S100 and S102 in FIG. 4. In the present modification, “send an instruction for updating the firmware” may be omitted. In another modification, the installer 50 may not execute the process of S100. That is, in S102 the installer 50 may send the update instruction to the target MFP irrespective of whether it is necessary to update the firmware of the target MFP or not.

(Modification 13) In the above embodiments, each process of FIGS. 3 to 8 is executed by software (i.e., the installer 50) but at least one of the process may be realized by hardware such as logic circuitry.

What is claimed is:

1. A non-transitory computer-readable recording medium storing an installer program for installing a control program for controlling a communication device on a terminal device,
wherein the installer program, when executed by a processor of the terminal device, causes the terminal device to:
acquire specific device information related to a specific communication device;
acquire, by using the specific device information, service information related to a consumable article shipping service for shipping a consumable article to a user of the specific communication device;
display, by using the service information, introduction information for introducing the consumable article shipping service to the user on a display of the terminal device; and
install, by using the specific device information, the control program on the terminal device.

2. The non-transitory computer-readable recording medium according to claim 1, wherein
the specific device information includes model identification information for identifying a model of the specific communication device, and
the service information is related to the consumable article shipping service according to the model identified by the model identification information included in the specific device information.

3. The non-transitory computer-readable recording medium according to claim 2, wherein
the control program compatible with the model identified by the model identification information included in the specific device information is installed on the terminal device.

4. The non-transitory computer-readable recording medium according to claim 1, wherein
in a case where the consumable article shipping service has not been provided to the user, the introduction information is displayed on the display, and
in a case where the consumable article shipping service has been provided to the user, the introduction information is not displayed on the display.

5. The non-transitory computer-readable recording medium according to claim 4, wherein
the installer program, when executed by the processor, further causes the terminal device to:
in a case where the consumable article shipping service has been provided to the user and authentication information for logging in to a server related to provision of the consumable article shipping service is not stored in a predetermined area of a memory of the terminal device, display an input screen for accepting an input of information for storing the authentication information in the predetermined area, and
in a case where the consumable article shipping service has been provided and the authentication information is stored in the predetermined area, the input screen is not displayed,
wherein the predetermined area is an area which can be referenced by a different program from the installer program, and
the different program can log in to the server by using the authentication information in the predetermined area.

6. The non-transitory computer-readable recording medium according to claim 1,
wherein the installer program, when executed by the processor, further causes the terminal device to:
store authentication information for logging in to a server related to provision of the consumable article shipping service in a predetermined area of a memory of the terminal device, wherein
the predetermined area is an area which can be referenced by a different program from the installer program, and
the different program can log in to the server by using the authentication information in the predetermined area.

7. The non-transitory computer-readable recording medium according to claim 1,
wherein the introduction information is displayed on the display after the control program has been installed.

8. The non-transitory computer-readable recording medium according to claim 1,
wherein the introduction information is displayed on the display during installation of the control program.

9. The non-transitory computer-readable recording medium according to claim 1,
wherein the introduction information is displayed on the display before installation of the control program is started.

10. The non-transitory computer-readable recording medium according to claim 1,
wherein the installer program, when executed by the processor, further causes the terminal device to:
in a case where an instruction for starting to provide the consumable article shipping service is accepted from the user after the introduction information has been displayed, and updating of a firmware of the specific communication device enables the consumable article shipping service to be provided to the user, send an instruction for updating the firmware to the specific communication device.

11. A terminal device, comprising:
a controller,
wherein the controller is configured to:
acquire specific device information related to a specific communication device which is a control object for a control program to be installed on the terminal device,
acquire, by using the specific device information, service information related to a consumable article shipping service for shipping a consumable article to a user of the specific communication device;
display, by using the service information, introduction information for introducing the consumable article shipping service to the user; and
install, by using the specific device information, the control program on the terminal device.

12. A method for controlling a terminal device, the method comprising:
acquiring specific device information related to a specific communication device which is a control object for a control program to be installed on the terminal device,
acquiring, by using the specific device information, service information related to a consumable article shipping service for shipping a consumable article to a user of the specific communication device;
displaying, by using the service information, introduction information for introducing the consumable article shipping service to the user; and
installing, by using the specific device information, the control program on the terminal device.

13. The method according to claim 12, wherein
the specific device information includes model identification information for identifying a model of the specific communication device, and
the service information is related to the consumable article shipping service according to the model identified by the model identification information included in the specific device information.

14. The method according to claim 13, wherein
the control program compatible with the model identified by the model identification information included in the specific device information is installed on the terminal device.

15. The method according to claim 12, wherein
in a case where the consumable article shipping service has not been provided to the user, the introduction information is displayed on the display, and
in a case where the consumable article shipping service has been provided to the user, the introduction information is not displayed on the display.

16. The method according to claim 15, wherein the method further comprising:
in a case where the consumable article shipping service has been provided to the user and authentication information for logging in to a server related to provision of the consumable article shipping service is not stored in a predetermined area of a memory of the terminal device, displaying an input screen for accepting an input of information for storing the authentication information in the predetermined area, and
in a case where the consumable article shipping service has been provided and the authentication information is stored in the predetermined area, the input screen is not displayed,
wherein the predetermined area is an area which can be referenced by a different program from the installer program, and
the different program can log in to the server by using the authentication information in the predetermined area.

17. The method according to claim 12, wherein the method further comprising:
storing authentication information for logging in to a server related to provision of the consumable article shipping service in a predetermined area of a memory of the terminal device, wherein
the predetermined area is an area which can be referenced by a different program from the installer program, and
the different program can log in to the server by using the authentication information in the predetermined area.

18. The method according to claim 12, wherein
the introduction information is displayed on the display after the control program has been installed.

19. The method according to claim 12, wherein
the introduction information is displayed on the display during installation of the control program.

20. The method according to claim 12, wherein
the introduction information is displayed on the display before installation of the control program is started.
